(19) United States
(12) Patent Application Publication
(10) Pub. No.: US 2024/0003520 A1
(43) Pub. Date: Jan. 4, 2024

(54) ILLUMINATED SUBSTRATE WITH PERFORATIONS

(71) Applicant: Joyson Safety Systems Acquisition LLC, Auburn Hills, MI (US)

(72) Inventors: Kurt Kastelic, Auburn Hills, MI (US); Jason Lisseman, Auburn Hills, MI (US)

(21) Appl. No.: 18/341,189

(22) Filed: Jun. 26, 2023

Related U.S. Application Data
(60) Provisional application No. 63/357,407, filed on Jun. 30, 2022.

(51) Int. Cl. F21V 11/14; F21V 5/00

(52) U.S. Cl. CPC F21V 11/14; F21V 5/00; F21Y 2115/10

(57) ABSTRACT

An illuminated substrate according to various implementations comprises a first surface and a second surface. The illuminated substrate defines perforations. A light diffusing layer is coupled to the first surface and overlays the perforations. A light source is disposed adjacent the second surface and emits light into the perforations. The light travels through the perforations from the second surface to and out of the first surface. The light then travels through the light diffusing layer. The perforations are arranged in a shape of an icon, and a shape of the light diffusing layer mimics the shape of the icon and ensures the light is evenly diffused. A coating is applied to the first surface and the light diffusing layer to provide protection, a smooth texture, a consistent appearance, and/or surface features.

### CROSS-REFERENCE TO RELATED APPLICATIONS

This application claims priority to and the benefit of U.S. Provisional Patent Application No. 63/357,407, filed Jun. 30, 2022, which is incorporated herein by reference in its entirety.

### TECHNICAL FIELD

The present disclosure relates to trim materials for passenger vehicles. In particular, the disclosure relates to a substrate with perforations that can be illuminated for aesthetic or functional purposes. Passenger vehicles may include, for example, any vehicle for transporting passengers, such as automobiles, trains, aircraft, and spacecraft.

### BACKGROUND

There is currently no cost-effective solution available to enable illumination of graphics, icons, or patterns through complex materials, such as carbon fiber or wood. For example, illuminated carbon fiber substrates comprise icons that are typically formed by removing material by manual machining. The area of removed material is then backfilled by hand with a light transmitting material to allow a light source to illuminate the icon. For wood, typically the material is machined on one side to form a blind hole icon, thereby thinning the wood to the point where light can be visible through the remaining material. However, the remaining material can make the icon appear cloudy due to the remaining natural wood which can diffuse the light in inconsistent ways. Additionally, icons for illumination can be added to wood through the same carbon fiber process above. As modern vehicles use more complex materials and have more buttons and switches than ever before, there is a desire for efficient and cost-effective solutions to enable consistent and aesthetically pleasing illuminated substrates of complex materials.

### SUMMARY

Various implementations include an illuminated substrate comprising a first surface and a second surface. The substrate defines perforations extending through the substrate from the first surface to the second surface. A light diffusing layer is coupled to the first surface and covers the perforations. The illuminated substrate further comprises a light source disposed adjacent the second surface, wherein the light source emits light into the perforations. Light from the light source exits from the first surface and through the light diffusing layer, thus producing a consistent, uniform appearance. In some implementations, a coating covers the first surface and the light diffusing layer, protecting the substrate and further providing for a smooth, consistent appearance. In some implementations, the perforations may be in the shape of an icon. In some implementations, the perforations are filled with a light transmitting material.

In other implementations, an illuminated substrate comprises a first surface and a second surface. The substrate defines perforations extending through the substrate from the first surface to the second surface. The illuminated substrate further comprises a light source disposed adjacent the second surface, wherein the light source emits light into the perforations. Light from the light source exits from the first surface. In some implementations, a coating covers the first surface, protecting the substrate and further providing for a smooth, consistent appearance. In some implementations, the perforations may be in the shape of an icon. In some implementations, the perforations are filled with a light transmitting material.

### BRIEF DESCRIPTION OF THE DRAWINGS

The drawings are merely exemplary to illustrate structure and certain features that can be used singularly or in combination with other features. The disclosure should not be limited to the implementations shown. Like reference numerals designate corresponding parts throughout the drawings.

FIG. 1 is a cross sectional view of an illuminated substrate with perforations according to one implementation.

FIG. 2 is an expanded view of the implementation of FIG. 1.

FIG. 3 is a top view of the implementation of FIG. 1 with the perforations defining an icon having a shape.

FIG. 4 is a top view of the implementation of FIG. 1 with the perforations defining an icon having a shape.

FIG. 5 is a top view of the implementation of FIG. 1 with the perforations defining an icon having a shape.

FIG. 6 is a cross sectional view of an illuminated substrate with perforations according to another implementation.

FIG. 7 is a top view of the implementation of FIG. 6 with the perforations defining an icon having a shape.

FIG. 8 is a flowchart of a process for forming the illuminated substrate according to one implementation.

### DETAILED DESCRIPTION

The present disclosure relates to trim materials for passenger vehicles. The devices, systems, and methods disclosed herein provide for a substrate with perforations that can be illuminated for aesthetic or functional purposes. The illuminated substrate may be installed in a vehicle as a decorative trim piece or as an indicator for a functional button or switch, for example. The illuminated substrate comprises a substrate comprising a first surface and a second surface and defining perforations extending from the first surface through to the second surface. A light source is disposed adjacent to the second surface and the perforations, allowing light to be transmitted from the light source into the perforations and out the first surface, therefore being visible to a passenger of the vehicle.

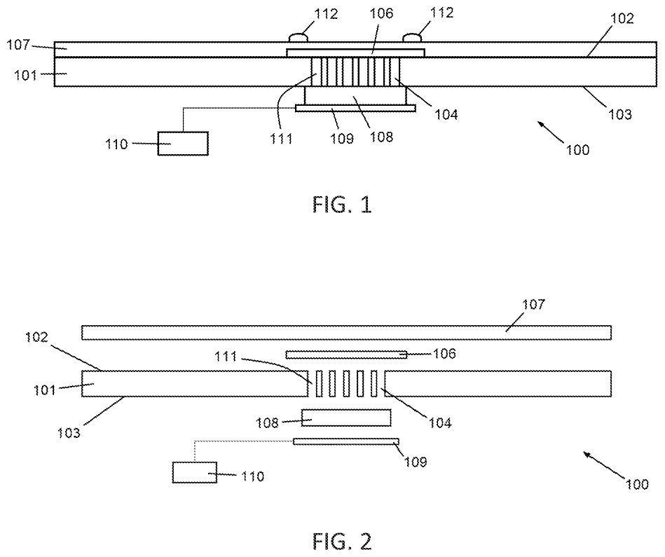

As shown in FIGS. 1-2, an illuminated substrate 100 of a first implementation comprises a substrate 101. The substrate 101 may be made from complex materials comprising, but not limited to, woods, composites, carbon fibers, plastics, and metals. The substrate 101 comprises a first surface 102 and a second surface 103 and defines perforations 104 extending from the first surface 102 through to the second surface 103. The perforations are covered by a light diffusing layer 106 which is coupled to the first surface 102. The first surface 102 and the light diffusing layer 106 are covered with a coating 107. A light source 108 is disposed adjacent the second surface 103 and the perforations 104. The light source 108 is coupled to a printed circuit board (PCB) 109, which in turn is electrically coupled to a controller 110 for controlling the light source 108. In other implementations, the light source may be electrically coupled to the controller without using a PCB. In some implementations, the light source 108 may comprise a visible light producing light emitting diode (LED). In some implementations, the light source 108 may comprise an array of multiple visible light producing LEDs.

The light diffusing layer 106 may comprise a light diffusing film or multiple layers of light diffusing films, for example plastic films such as, but not limited to, polypropylene or polyethylene films. When light from the light source 108 is transmitted through the perforations 104 and out the first surface 102, the light will pass through the light diffusing layer 106. The light diffusing layer 106 diffuses the light, thereby avoiding the appearance of “hot spots.” Thus, the light will appear consistent and uniform to a vehicle passenger. In some implementations, the light diffusing layer may comprise a lens, a coating, or any other material capable of diffusing the light from the light source to provide a consistent and uniform appearance. The light diffusing layer 106 may be coupled to the first surface 102 via an adhesive or an epoxy, for example, but may be coupled to the first surface 102 in any way that will provide adhesion without affecting the light diffusing nature.

The coating 107 is applied over the first surface 102 and the light diffusing layer 106 in order to provide a smooth and consistent appearance. The coating 107 may be selected from the group consisting of lacquers, epoxies, and resins that are transparent or translucent to ensure light transmission, for example polyurethane or polyester lacquers and injection molded clear polyurethanes. In addition to the appearance benefits, the coating 107 aids in bonding the light diffusing layer 106 to the first surface 102. Once applied, the coating 107 may be polished for a smooth and consistent finish and/or machined to define surface features, such as dimples or protrusions 112 (shown in FIG. 1) to identify a functional element, such as a button or switch. In some implementations, the coating may be applied in multiple coats, for example by applying one layer of coating, curing that layer, then applying another layer. This process can continue for as many layers as required for a given application.

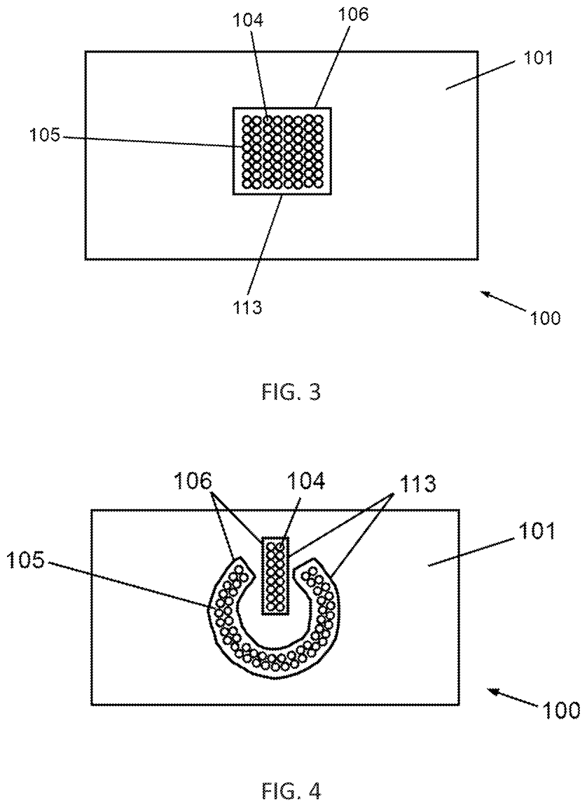

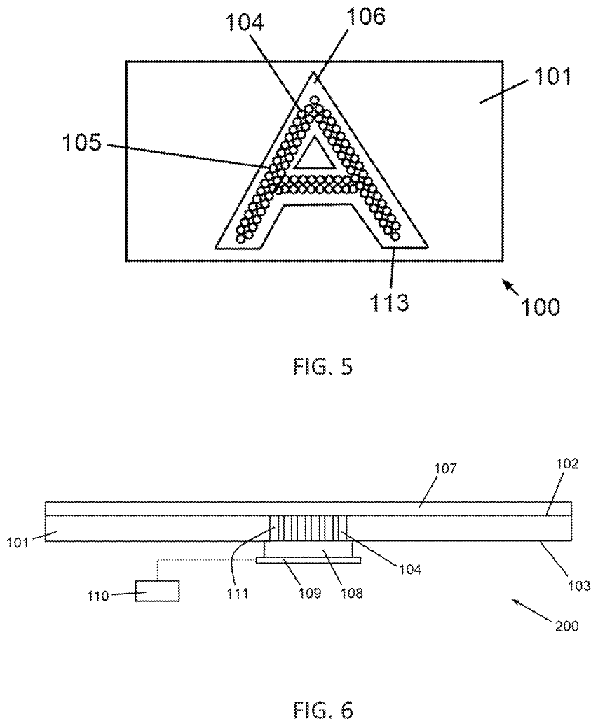

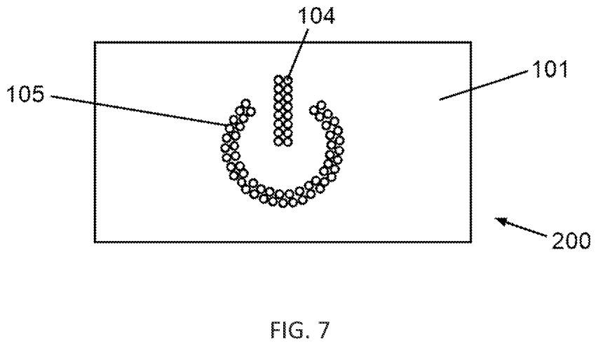

Perforations 104 comprise holes bored out from the first surface 102 through the substrate 101 to the second surface 103, thus forming a pathway for light from the light source 108 to travel through the substrate 101. In the implementations shown in the FIGURES, the perforations 104 are cylindrically shaped with a circular cross-section as viewed from either the first surface 102 or the second surface 103. In other implementations, the perforations may be cylindrically shaped with a non-circular cross-section as viewed from either the first surface or the second surface, for example square, oval, triangular, or any other desired shape. The perforations 104 are formed so as to visually represent an icon having a shape 105, for example a letter, number, or image such as a power button indicator (shown in FIGS. 4 and 7) or some other image as is required for a particular use case. The light diffusing layer 106 may also be formed in a shape 113 that matches the shape 105 of the icon, as shown in FIGS. 3-5.

The perforations 104 may be formed by laser drilling. In other implementations, the perforations may be formed by mechanical drilling, water jet, or injection molding, for example. In the implementations shown in the FIGURES with circular cross-section, the diameter of the perforations 104 may be as small as 50 micrometers and as large as 10 millimeters. Preferably, the diameter of the perforations 104 ranges anywhere between 100 micrometers and 10 millimeters, inclusive of the end points of the range. More preferably, the perforations 104 range from 0.1 to 1 millimeters in diameter. In other implementations, for perforations with a non-circular cross-section, the widest dimension of the perforations may be as small as 50 micrometers and as large as 10 millimeters, preferably between 100 micrometers and 10 millimeters, and more preferably between 0.1 to 1 millimeters, inclusive of all range end points.

A light transmitting material 111 may be disposed within the perforations 104 to allow for optimized light transmission through the perforations 104. Additionally, the light transmitting material 111 may serve a similar role as the light diffusing layer 106, helping to diffuse the light as it passes through the perforations 104. The light transmitting material 111 may be selected from the group consisting of lacquers, epoxies, and resins that are transparent or translucent to ensure light transmission, for example polyurethane or polyester lacquers and injection molded clear polyurethanes. The light transmitting material 111 may be the same material as the coating 107 or it may be a different material.

Referring now to FIGS. 6-7, an illuminated substrate 200 according to a second implementation is shown. The illuminated substrate 200 is substantially the same as the illuminated substrate 100, however the illuminated substrate 200 of the second implementation does not include a light diffusing layer. In this implementation, the light transmitting material 111 may be the same material as the coating 107 and may fill the perforations 104 in the same step as the application of the coating 107 such as, for example, by gravity filling the perforations 104 when the coating 107 is applied to the first surface 102 of the substrate 101. Additionally, or alternatively, mechanical, pneumatic, or other methods may be used to ensure the light transmitting material 111 fills the perforations 104. In some implementations, the light transmitting material may be a different material than the coating and be disposed inside the perforations before coating the first surface with the coating.

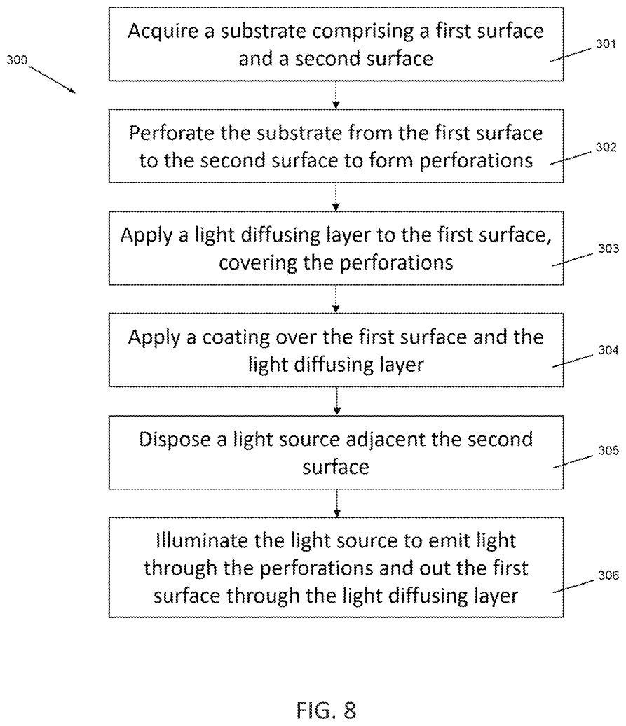

FIG. 8 represents a flow chart of steps to be performed for a method 300 of producing the illuminated substrate 100 of the first implementation. At step 301, a substrate is acquired comprising a first surface and a second surface. Then, at step 302, the substrate is perforated to form perforations extending from the first surface to the second surface. Next, at step 303, a light diffusing layer is applied to the first surface over the perforations. At step 304, a coating is applied over the first surface and the light diffusing layer. At step 305, a light source is disposed adjacent the second surface and the perforations. Finally, at step 306, the light source is illuminated to emit light through the perforations and out the first surface and light diffusing layer. It will be understood by one of ordinary skill in the art that the illuminated substrate 200 of the second implementation may be made by the same method by eliminating step 303 and modifying steps 304 and 306 by removing reference to the light diffusing layer.

A number of implementations have been described. The description in the present disclosure has been presented for purposes of illustration but is not intended to be exhaustive or limited to the implementations disclosed. It will be understood that various modifications and variations will be apparent to those of ordinary skill in the art and may be made without departing from the spirit and scope of the claims. Accordingly, other implementations are within the scope of the following claims. The implementations described were chosen in order to best explain the principles of the illuminated substrate and its practical application, and to enable others of ordinary skill in the art to understand the illuminated substrate for various implementations with various modifications as are suited to the particular use contemplated.

The terminology used herein is for the purpose of describing particular implementations only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, operations, elements, steps, and/or components, but do not preclude the presence or addition of one or more other features, operations, elements, steps, components, and/or combinations thereof.

What is claimed is:

1. An illuminated substrate comprising:
a substrate comprising a first surface and a second surface, the substrate defining perforations extending through the substrate from the first surface to the second surface;
a light diffusing layer coupled to the first surface and covering the perforations;
a coating over the first surface and the light diffusing layer; and
a light source adjacent the second surface;
wherein the light source emits light into the perforations, and
wherein the light exits from the first surface and through the light diffusing layer.

2. The illuminated substrate of claim 1, wherein the light diffusing layer is a plastic film.

3. The illuminated substrate of claim 1, wherein the perforations are filled with a light transmitting material.

4. The illuminated substrate of claim 1, wherein the coating defines a dimple or protrusion.

5. The illuminated substrate of claim 1, wherein the coating is selected from the group consisting of lacquers, epoxies, and resins.

6. The illuminated substrate of claim 1, wherein the light source comprises an LED.

7. The illuminated substrate of claim 1, wherein the light source comprises an array of LEDs.

8. The illuminated substrate of claim 1, wherein the perforations define an icon having a shape.

9. The illuminated substrate of claim 8, wherein a shape of the light diffusing layer matches the shape of the icon.

10. The illuminated substrate of claim 1, wherein the substrate is selected from the group consisting of woods, composites, carbon fibers, plastics, and metals.

11. The illuminated substrate of claim 9, wherein the light diffusing layer is a plastic film.

12. An illuminated substrate comprising:
a substrate comprising a first surface and a second surface, the substrate defining perforations extending through the substrate from the first surface to the second surface;
a coating over the first surface; and
a light source adjacent the second surface;
wherein the light source emits light into the perforations, and
wherein the light exits from the first surface.

13. The illuminated substrate of claim 12, wherein the perforations are filled with a light transmitting material.

14. The illuminated substrate of claim 12, wherein the coating defines a dimple or protrusion.

15. The illuminated substrate of claim 12, wherein the coating is selected from the group consisting of lacquers, epoxies, and resins.

16. The illuminated substrate of claim 12, wherein the light source comprises an LED.

17. The illuminated substrate of claim 12, wherein the light source comprises an array of LEDs.

18. The illuminated substrate of claim 12, wherein the perforations define an icon having a shape.

19. The illuminated substrate of claim 13, wherein the perforations define an icon having a shape.

20. The illuminated substrate of claim 12, wherein the substrate is selected from the group consisting of woods, composites, carbon fibers, plastics, and metals.
